(19) United States
(12) Patent Application Publication
(10) Pub. No.: US 2005/0084836 A1
(43) Pub. Date: Apr. 21, 2005

(54) Method and media for educating and entertaining using storytelling with sound effects, narration segment and pauses

(75) Inventor: Gail Anderson, Leesburg, VA (US)

Correspondence Address: BURNS DOANE SWECKER & MATHIS L L P, POST OFFICE BOX 1404, ALEXANDRIA, VA, 22313-1404, US

(73) Assignee: GiGi Books, LLC, Leesburg, VA (US)

(21) Appl. No.: 10/687,624

(22) Filed: Oct. 20, 2003

(51) Int. Cl. G09B 5/00

(52) U.S. Cl. 434/308

(57) ABSTRACT

Storytelling with sound effects, narration and breaks in the dialogue to permit pausing the playback of a recording media is disclosed to foster imagination, education and communication among listeners. The method provides a vehicle for achieving these goals even when the listeners may be distracted, e.g., while driving, to optimize opportunities for education and entertainment.

### BACKGROUND OF THE INVENTION

1) Field of the Invention

The present invention relates to a method and media for instruction and/or education about a subject, and more particularly to a method and media where audio instruction is reproduced from an audio recording medium, the instruction being in the form of storytelling with sound effects and narration that poses questions and raises issues from the story.

2) Discussion of Related Art

A goal of parents of young children is to provide a safe, nurturing and learning environment to prepare their children for the trials and tribulations of life. Along these lines, many parents treasure their time with their children and attempt to maximize the amount of “quality time”.

One of the techniques employed by parents is to read to their children. Reading to children promotes language and reading skills, develops longer attention spans, answers children's questions and strengthens family relationships. In addition to improving a child's academic skills, children's stories often contain life lessons to facilitate their preparedness as they become adults.

However, even the best intentioned parent sometimes has to pay attention to other matters. In modern days, all too frequently parents resort to television, pre-recorded movies and the like to distract their children while they carry out chores such as house cleaning and yard maintenance. These forms of entertainment, such as movies, cartoons and the like does not usually exercise a child's imagination. Because the visualization of the story is provided to the child, the child simply does not have to imagine or visualize very much about the story, or to think about what is being conveyed to him or her, or require the use of the child's imagination. Much of children's television merely distracts without offering more.

One time period that has been under-utilized in the education of children, and is often a period of potential conflict between parents and children, is during road trips. During long road trips in particular, a child is apt to become antsy and bored. This often results in inappropriate behavior such as arguing, fighting, complaining or other misbehavior indicating the child's discomfort with the environment he or she is in.

Many parents have begun to resort to the use of portable or permanently installed video players to playback prerecorded movies and cartoons to distract the child during these road trips. Besides not fostering a child's imagination, what is lacking during the playback of prerecorded video programs is an opportunity for the parent to have meaningful dialogue with the child about the story. The parent cannot (or should not) be able to see the video while driving, for otherwise the parent might become distracted. Stated differently, parents would like to have an experience similar to reading to their children during long road trips or other like times, but reading is simply impossible while driving, and can give a person motion sickness if they read as a passenger.

### SUMMARY OF THE INVENTION

The present invention contemplates a solution to the exemplary problem posed by road trips or other times when a parent cannot devote his or her full attention to the child, but nevertheless yeans to provide quality time with that child. The present invention provides for audio storytelling with a difference. Conventional audio books simply provide the voice of someone reading the book verbatim, and these audio books tend to bore even adults. The problem is, of course, too many words are required to set up scenes and the narrator's voice becomes monotonous. Often, one reader also reads all the dialogue between characters in the story.

The present invention provides storytelling with sound effects to enhance visualization by the listener. As done in the golden age of radio, a story told using the present invention provides dialogue between characters of the story using different voices. Accompanying the dialogue is music and/or sound effects to facilitate the listener's, particularly the child's, visualization of the story as it is being told. Rather than simply watching the visualization provided through the imagination of a movie director for instance during video playback, the child's imagination can be exercised by facilitating visualization of the scenes in the story by himself or herself.

To further promote the quality of the understanding among the listeners, and in particular the children, the dialogue between characters is stopped, generally at the end of a scene, so that narration can selectively set up or explain scenes, raise issues, pose questions, and provide conclusions, as appropriate. Also, generally after a narration segment, an optional pause period in which no narration or dialogue occurs in the actual playback of the recording is provided so as to permit the parent or other audience member sufficient time to access the controls of the playback device, such as the car's CD player, in order to pause the playback of a CD, for instance. In this way, the parent, without becoming too distracted from the responsibilities of driving, can discuss the story with his or her children. In this way, meaningful discussion and communication between parent and child is promoted at a time such as a road trip when previously the parent had few choices as to entertaining and/or educating his or her children. Exemplary embodiments disclosed herein can provide an opportunity to do both while strengthening family values and bonds.

Also, it is important for listeners to understand that the audio recording that they are listening to is not the only one of its type. Instead, a prologue and/or an epilogue can be provided to explain the storytelling technique, its ability to promote visualization and/or the use of imagination by the listeners, while also facilitating learning of life's lessons and discussion among listeners. The prologues and/or epilogue does this while also identifying the book series and source, e.g., GiGi Books, where the parent for instance can obtain other stories that are told in a similar fashion.

### BRIEF DESCRIPTION OF THE DRAWINGS

The present invention will now be described by way of exemplary embodiments, to which it is not limited, with reference to the accompanying drawing figures, as follows.

FIG. 1 is a flow diagram of an exemplary embodiment in accordance with the present invention.

FIG. 2 is an illustration of an optical media playback device.

### DETAILED DESCRIPTION OF EXEMPLARY EMBODIMENTS

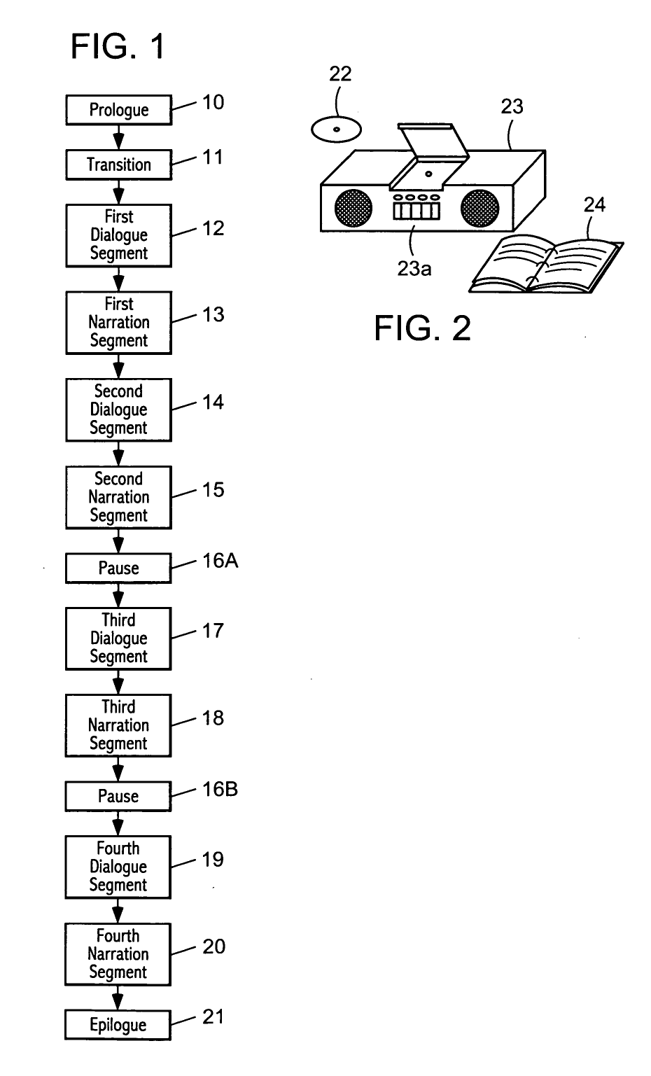

FIG. 1 illustrates an exemplary flow diagram in accordance with the following description.

The exemplary method of recording and/or playing back an educational story includes an optional prologue which in some embodiments provides a description of the story and the manner of its telling, as shown in FIG. 1. The prologue 10 also includes an indication that the method employed in telling the educational story is by a particular brand name, e.g., GiGi Books, LLC. This prologue 10 can serve a dual function of advertising the line of audio books while informing the listener as to what to expect for the rest of the playback of the recorded educational story. The prologue 10 is accompanied by sound effects such as footsteps, doorbells, door slams, car engines or any other suitable sound effect that helps the listener visualize through the listener's own imagination the scene being painted by the combination of the dialogue and the sound effects accompanying the dialogue.

After the prologue 10, there is a transition 11 which includes sound effects and/or music. Dialogue does not generally accompany the transitional segment, but could optionally use some dialogue or singing or the like. The transitional period permits the listener to shift from understanding the meaning of the prologue 10 to understanding that the story is about to be told.

After the transitional period 11, a first dialogue segment 12 begins. This dialogue segment 12 is also accompanied by sound effects to promote visualization through the imagination of the listener. The first dialogue segment 12 begins the story by introducing the characters and the theme of the story. While possible, the first dialogue segment 12 generally does not underline the issues or the moral or lesson to be learned from the story.

After the first dialogue segment 12, a first narration segment 13 is provided to the listener. The first narration segment 13 is generally provided by a narrator who is not a character in the story. It is also generally unaccompanied by sound effects or music to emphasize the importance of what is being said. The first narration segment 13 emphasizes the characteristics of the characters as evident from the first dialogue segment 12. The first narration segment 13 articulates the issues introduced in the first dialogue segment 12 and optionally the issues presented in the entire story.

In the next step, a second dialogue segment 14 between the characters in the story is used to emphasize the issue introduced in the first dialogue segment 12, as well as the first narration segment 13. The second dialogue segment 14 also includes sound effects to promote visualization of a story scene through the imagination of the listeners.

In the next step, a second narration segment 15 facilitates the listeners identification of the issues that have been presented in the first and second dialogue segments 12 and 14.

The next step can be a period of silence 16a in the playback of the recording, which is provided to permit a listener time to access the controls 23a of playback device 23 to pause the playback for a discussion between the listeners of the story as previously presented. For instance, in the second narration segment 15, the narrator could raise questions or simply suggest issues for discussion. During the period 16a when neither dialogue or narration occurs, a parent, for instance, could pause the playback of the recording so that the parent could discuss with his or her child or children the issues being presented and the morals to be learned. The pause is of a duration designed to permit someone to operate the controls 23a on the CD player 23, for instance, but not so long as to disrupt the overall storytelling. It has been empirically determined that approximately three to five seconds, and preferably four seconds, is sufficient in this regard.

This pause 16a of FIG. 1 facilitates communication among parent and children similar to the interaction that a parent and child might have in reading a story. The narration segments 13 and 15 help the listeners focus on the issues being presented and suggest topics for discussion. However, because it is not necessary to read the book or study written materials accompanying the book, it is suitable for playback during road trips, etc., when the parent may otherwise be required to give attention to other activities, such as driving. It could also be used when the parent is cooking, cleaning, or performing other related activities.

Also, because the break in dialogue and narration is short, an audio playback of the story in accordance with this aspect of the presently-disclosed method can be played by the child without the parent's interaction and without pausing the playback. In other words, the child can still be educated and entertained even without the parent's presence. The present method therefore can have a dual function in this regard.

A third dialogue segment 17 can be provided. The third dialogue segment 17 between the characters of the story can reemphasize the issue of the story or story segment, and begin to tell of the consequences of the actions of various characters in the story. The third dialogue segment 17 can also be accompanied by sound effects to promote the use of imagination by the listeners in visualizing the story scene. It should be noted that the third dialogue segment 17 may be optional as some stories do not require such a segment, particularly given the segments to follow.

As illustrated in the next step of FIG. 1, a third narration segment 18 summarizes the lessons learned from the consequences of the characters' actions in the story as previously told. As is the case with the other narration segments, the narration is generally voiced without accompaniment by sound effects to emphasize and differentiate the segment from the dialogue segments.

After the third narration segment 18, a second break 16b in dialogue and narration can be provided to the listeners. As with the first break 16a, the second break 16b is of a duration to permit a listener to pause the playback of the recording so that the essence of what is to be learned or that should be learned from the story can be discussed among the listeners.

After the second break 16b as shown in FIG. 1, which is optional, a fourth dialogue segment 19 can be provided to the listeners. The fourth dialogue segment 19 is designed to provide a resolution of the story, which may or may not include an articulation or rearticulation of the lessons learned. The fourth dialogue segment 19 is accompanied by sound effects promoting visualization of the story scene by the listeners, as is done in the other dialogue segments.

After the fourth dialogue segment 19, a fourth narration segment 20 is provided emphasizing the resolution of the story as previously told.

It should be noted that multiple sequences of dialogue segments followed by narration segments are also contemplated, particularly when telling multiple stories or stories with multiple lessons. Further, the present method also contemplates providing more or fewer periods of time when no dialogue or narration occurs periodically throughout the storytelling, and preferably after the narration segments, to permit the listeners to stop the playback and to discuss the story that they have just heard.

The sequence of the dialogue, narration and breaks permits and promotes discussion between the listeners about the story. In this manner, the present system promotes communication between audience members, which can facilitate an understanding of the story, an understanding of each other, and an understanding of society's morals, standards of behavior and expectations as well as consequences of unacceptable behavior. By providing discussion through narration and opportunities for further discussion as to what lessons should be learned from the story, the present method facilitates understanding in an environment where education and entertainment are possible but a discussion leader (e.g., a parent) is distracted by other responsibilities. The present method is particularly useful in environments wherein the discussion leader cannot devote all of their attention to the telling of the story and are unavailable for reading the story such as while driving. Also, because of the sound effects accompanying the dialogue, a child's imagination is exercised as an attempt to visualize the story being told through a combination of the sound effects and the narration.

It is believed that this form of storytelling is superior to the playback of videos insofar as a child's imagination is exercised. It is also superior to simply playing music insofar as music does not necessarily convey life's lessons and does not promote a discussion among audience members unless it is provided in a manner akin to the presently disclosed method. Storytelling following the present method is more entertaining than a conventional audio book.

Further modifications and adaptations of the present invention are contemplated. For instance, the present invention can be embodied on an audio media recording 22 of any nature, such as a magnetic tape or disk, a compact disk, or digital versatile disk, to name a few. The media can be a hard disk particularly if downloaded over a computer network such as the Internet.

Also, the audience member or purchaser may be able to choose among several versions of the narration. For instance, if the audience members have an affinity for a particular religion or cultural background, the narration can emphasize the social values and morals of that segment of society. This can be done at the time of ordering or purchasing the tape or optical recording media 22 and the appropriate version is shipped. With respect to digital versatile disks and compact disks for instance having the capability, a listener can optionally select which narration among multiple narration versions that are provided on the recording medium. For instance, in a digital versatile disk or a compact disk played back on a computer or other enabled device, a menu offering a selection among various religions or cultures can be provided to the listener for selection. If the listener selects “Christian” then narration can emphasize the Christian standards of society and conduct, such as provided in the Bible for instance. If Moslem, then the lessons of the Koran can be emphasized.

Additionally, the recording media 22 bearing the recording of the educational story can be accompanied by written material 24, such as work books and study guides as shown in FIG. 2. This written material 24 can reinforce the story and provide a mechanism to judge a child's comprehension level of the story.

As shown in FIG. 1, an epilogue 21 can also be provided. The epilogue can reiterate the format of the story, suggest to the listeners other titles, and/or other sources of further books following this education and entertainment method.

The foregoing invention has been described by way of exemplary embodiments to which it is not limited. The full scope and meaning of the invention can be ascertained through a study of the claims appended hereto. Modifications and adaptations will occur to those skilled in the art without departing from the scope of the invention as contemplated herein.

1. A method of recording or playing back a recorded educational story, comprising:
providing a first dialogue segment between characters in the story establishing a context for the story, said first dialogue segment being accompanied by sound effects to promote visualization of a story scene by listeners;
providing a first narration segment articulating an issue being presented in the first dialogue segment;
providing a second dialogue segment between characters in the story emphasizing the issue, said second dialogue segment being accompanied by sound effects to promote visualization of a story scene by listeners;
providing a second narration segment identifying the issues that have been presented;
providing a concluding dialogue segment between characters in the story providing resolution of the story, said concluding dialogue segment being accompanied by sound effects promoting visualization of the story scene by listeners;
providing concluding narration emphasizing the resolution of the story segment; and
providing one or more periods when no dialogue or narration occurs, said one or more periods of a duration to permit a listener to use a pause control on a playback device to pause the playback of the recorded story,
wherein said sequence of dialogue, narration and periods for pausing the playback promotes discussion between audience members about the story.

2. A method in accordance with claim 1, further comprising providing at least one of study guides and work books for review during the audio playback.

3. A method in accordance with claim 1, further comprising providing the ability for a prospective listener to select one narration category from a plurality of narration categories for playback.

4. A method in accordance with claim 1, wherein said periods for pausing is of a duration designed to permit a listener to control the playback device without undue interruption in the audio playback.

5. A method in accordance with claim 4, wherein said periods for pausing is four seconds in duration.

6. A method in accordance with claim 1, wherein said listener includes at least one parent and at least one child.

7. A method in accordance with claim 1, further comprising repeating said first dialogue segment, first narration segment, second dialogue segment, second narration segment, concluding dialogue segment and concluding narration segment for different parts of a story.

8. A method in accordance with claim 1, further comprising:
reproducing a prologue promoting the brand name of the company providing the audio recording; and
transitioning from the prologue to a story with music and sound effects.

9. A method in accordance with claim 1, further comprising:
transitioning from the story using music and sound effects; and
providing an epilogue promoting a brand name of a company proving the audio recording.

10. A method in accordance with claim 1, further comprising, after the second narration segment and before the concluding dialogue segment;
providing at least one dialogue segment between characters in the story, reemphasizing the issue, and telling of consequences of the characters' actions in the story, said at least one dialogue segment being accompanied by sound effects to promote visualization of a story scene by the listeners; and
providing a narration segment summarizing the lessons learned from the consequences of the characters' actions in the story.

11. A recording media having recorded thereon data capable of being reproduced as audible sound when played in an audio playback device, said audio playback being in accordance with the following method:
providing a first dialogue segment between characters in the story establishing a context for the story said first dialogue segment being accompanied by sound effects to promote visualization of a story scene by listeners;
providing a first narration segment articulating an issue being presented in the first dialogue segment;
providing a second dialogue segment between characters in the story emphasizing the issue, said second dialogue segment being accompanied by sound effects to promote visualization of a story scene by listeners;
providing a second narration segment identifying the issues that have been presented;
providing a concluding dialogue segment between characters in the story providing resolution of the story, said concluding dialogue segment being accompanied by sound effects promoting visualization of the story scene by listeners;
providing concluding narration emphasizing the resolution of the story segment; and
providing one or more periods when no dialogue or narration occurs, said one or more periods of a duration to permit a listener to use a pause control of a playback device to pause the playback of the recorded story,
wherein said sequence of dialogue, narration and periods for pausing the playback promotes discussion between audience members about the story.

12. A recording media in accordance with claim 11, wherein said method further comprising providing written materials for review during the audio playback.

13. A recording media in accordance with claim 11, wherein said method further comprises providing the ability for a prospective listener to select one narration category from a plurality of narration categories for playback.

14. A recording media in accordance with claim 11, wherein said periods for pausing is of a duration designed to permit a listener to control the playback device without undue interruption in the audio playback.

15. A recording media in accordance with claim 11, wherein said periods for pausing is three to five seconds in duration.

16. A recording media in accordance with claim 11, wherein said method further comprises repeating said first dialogue segment, first narration segment, second dialogue segment, second narration segment, concluding dialogue segment and concluding narration segment for different parts of a story.

17. A recording media in accordance with claim 11, wherein said method further comprises:
reproducing a prologue promoting the brand name of the company providing the audio recording; and
transitioning from the prologue to a story with music and sound effects.

18. A recording media in accordance with claim 11, wherein said method further comprises:
transitioning from the story using music and sound effects; and
providing an epilogue promoting a brand name of a company providing the audio recording.

19. A recording media in accordance with claim 11, wherein said method further comprises, after the second narration segment and before the concluding dialogue segment;
providing at least one dialogue segment between characters in the story, reemphasizing the issue, and telling of consequences of the characters' actions in the story, said third dialogue segment being accompanied by sound effects to promote visualization of a story scene by the listeners; and
providing at least one narration segment summarizing the lessons learned from the consequences of the characters' actions in the story.
